(19) United States
(12) Patent Application Publication
(10) Pub. No.: US 2011/0199854 A1
(43) Pub. Date: Aug. 18, 2011

(54) FLASH TANKS

(76) Inventors: Christopher Gordon Coleman, Queensland (AU); Jie Wu, Victoria (AU)

(21) Appl. No.: 12/999,533

(22) PCT Filed: Jun. 17, 2009
(86) PCT No.: PCT/AU2009/000775

§ 371 Date: Apr. 27, 2011

(30) Foreign Application Priority Data
Jun. 17, 2008 (AU) 2008202664

(51) Int. Cl. B01F 15/02; B01F 15/06

(52) U.S. Cl. 366/144; 366/165.1

(57) ABSTRACT

A method and an apparatus for supplying a slurry at high temperature and pressure, such as a process slurry from Bayer process digestion units, to a tank is disclosed. The process and the apparatus at least substantially eliminates bottom settling of solid particulate material and side wall scale by supplying the process slurry from Bayer process digestion units with a swirling motion into flash tanks.

The present invention relates to tanks for cooling process slurries that are at high temperatures and high pressures to atmospheric pressure.

The present invention relates particularly, although by no means exclusively, to tanks for flash cooling such high temperature and high pressure process slurries, particularly slurries that are at temperatures higher than the saturation temperature corresponding to the operating pressures of the tanks.

The present invention relates more particularly, although by no means exclusively, to tanks for flash cooling high temperature and pressure process slurries from digestion units of Bayer process plants for producing alumina.

The Bayer process comprises the following major unit operations.
(a) Digesting bauxite in caustic soda in digestion units and forming a high temperature and high pressure process slurry in the form of (i) a liquor containing sodium aluminate in solution and (ii) solid particulate material, principally inert iron and titanium oxides and silica compounds, entrained in the liquor.
(b) Separating the liquor and the solid particulate material.
(c) Precipitating alumina trihydrate from the liquor.
(d) Calcining the precipitated aluminium trihydrate and forming alumina.

The high temperature and high pressure process slurry produced in the digestion units is discharged from the units and flash-cooled to atmospheric pressure in a series of tanks operating at successively lower pressures. The flash steam generated in the flash tanks is used beneficially in the Bayer process, typically to pre-heat caustic soda used in the digestion tanks.

The applicant has carried out research and development work in relation to flash tanks used in an alumina plant operated by the applicant. Details of the actual flash tank are provided in example 4 set out below.

The applicant has identified in the work that one problem with the flash tanks is a build-up of solid particulate material in the bottoms of the tanks and on the side walls of the tanks when the tanks were operated at design or near design operating levels. The build-up of solid particulate material in the bottoms of the tanks was due to material settling out from the process slurry in the tanks. The build-up of solid particulate material on the side walls of the tanks was due to the process slurry being splashed onto the tank side walls and forming as scale on the walls.

The above-described build-up of solid particulate material is a problem because it caused significant lost production.

Specifically, the applicant found that, while operating under these operating conditions:
(a) the settled solids in the bottoms of the flash tanks formed significant-sized consolidated settled material;
(b) the scale periodically broke away from the tank side walls and dropped to the bottoms of the tanks;
(c) there was a turbulent slurry/vapour interface and this resulted in difficulties accurately determining the level of process slurry in the tanks; and
(d) there were frequent tank blockages of tank outlets caused by (i) consolidated settled material migrating over the outlets or (ii) scale detaching from the tank side walls and blocking the outlets.

In view of the above, there was significant lost production when the flash tanks were operated at design or near design operating levels due to the down-time required to clear blockages in the tank outlets.

In addition, there was significant lost production when the tanks were operated at lower than design or near design operating levels at which the build-up of solid particulate material was not as significant an issue.

The above discussion is not to be taken as an admission of the common general knowledge in Australia or elsewhere.

The applicant found in the research and development work that it was possible to at least substantially eliminate bottom settling of solid particulate material and side wall scale by supplying a slurry from Bayer process digestion units with a swirling motion into the flash tanks.

According to the present invention there is provided an apparatus for supplying a slurry into a tank comprising:
(a) a riser tube comprising an inlet for receiving the slurry into the tube and an outlet for discharging the slurry from the tube; and
(b) an assembly for imparting a swirling motion to the slurry.

The term “swirling motion” is understood herein to mean that the flow of the slurry is generally in a curved path, such as (but not limited to) a spiral path.

The slurry may be at a temperature higher than the saturation temperature corresponding to an operating pressure of the tank.

The apparatus may be positioned in the tank with the riser tube mounted to a bottom of the tank and extending upwardly, such as vertically upwardly, in the tank, such as centrally in the tank, with the outlet positioned above a pool of the slurry in the tank, and the inlet receiving the slurry from a unit operation, such as a Bayer process digestion unit, upstream of the tank and the slurry flowing upwardly in the riser tube and being discharged with the swirling motion outwardly from the outlet of the riser tube.

The swirling assembly may be positioned at the outlet of the riser tube.

The swirling assembly may comprise a plurality of curved blades positioned in a flow path of the slurry at the outlet of the riser tube.

Alternatively, the swirling assembly may comprise a plurality of impeller blades positioned in the slurry flow path at the outlet of the riser tube.

Alternatively, the swirling assembly may comprise a plurality of rotatable vanes positioned in the slurry flow path at the outlet of the riser tube.

The swirling assembly may further comprise a deflector positioned directly above the outlet of the riser tube for deflecting the slurry flowing from the outlet of the riser tube downwardly when the assembly is positioned in the tank.

The deflector may comprise a cap having a top wall and optionally a downwardly-depending skirt that is positioned on the swirling assembly so that, in use, the slurry that flows from the outlet of the riser tube contacts the top wall and/or the skirt (if present) and is deflected downwardly in the tank.

According to the present invention there is also provided a tank for cooling a slurry, the tank comprising:
(a) the above-described apparatus. for supplying the slurry to be cooled into the tank positioned in the tank, and
(b) at least one outlet for cooled slurry from the tank.

The tank may be a tank for flash cooling a slurry that is at a temperature higher than the saturation temperature corresponding to an operating pressure of the tank.

The tank may be a tank for flash cooling a slurry from digestion units of Bayer process plants for producing alumina.

According to the present invention there is also provided a method of processing a slurry that comprises supplying the slurry with a swirling motion into a tank that contains a pool of the slurry.

The method may comprise supplying the slurry with the swirling motion into the tank above a surface of the pool of the slurry in the tank.

The method may comprise supplying the slurry with the swirling motion into the tank in a downward direction within the tank.

The method may comprise supplying the slurry in an upward flow, such as a vertically upward flow, from a bottom of the tank via a riser tube positioned in the tank and imparting the swirling motion to the slurry as it flows from an outlet of the tube at an upper end of the tube.

The method may comprise supplying the slurry at a temperature higher than the saturation temperature corresponding to an operating pressure of the tank and flash cooling the slurry in the tank.

The method may comprise controlling the level of the pool of the slurry in the tank.

The tank may be the above-described tank.

The present invention is described further by way of example with reference to the accompanying drawings, of which:

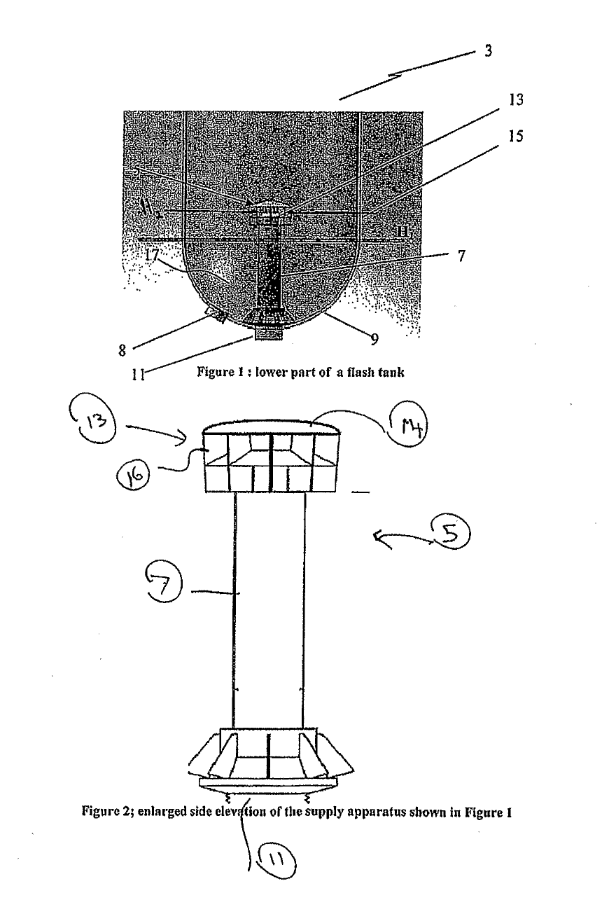

FIG. 1 is a schematic drawing of a lower part of one embodiment of a known flash tank prior to modifications to a supply apparatus for a slurry shown in the Figure that change the tank into a flash tank in accordance with an embodiment of the present invention;

FIG. 2 is an enlarged side elevation of the supply apparatus shown in FIG. 1;

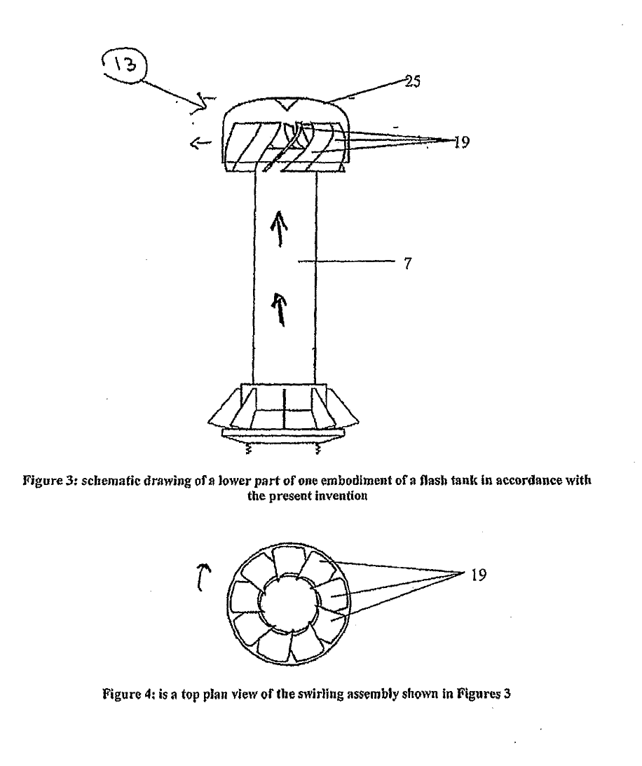

FIG. 3 is a schematic drawing of a lower part of one embodiment of a flash tank in accordance with the present invention that comprises one embodiment of an apparatus for supplying a slurry to the tank in accordance with the present invention;

FIG. 4 is a top plan view of the swirling assembly of the supply apparatus shown in FIG. 3, with the top cap of the assembly removed for clarity;

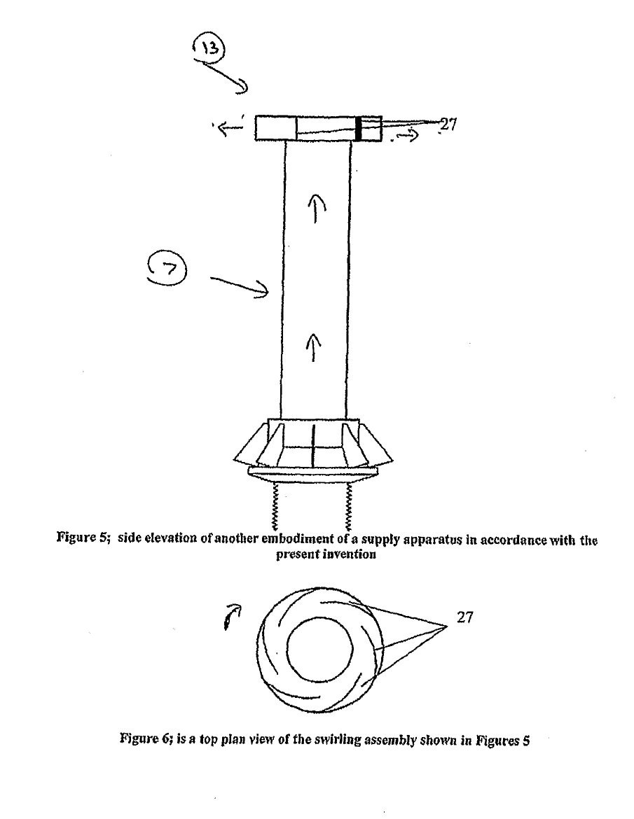

FIG. 5 is a side elevation of another, although not the only other possible, embodiment of a supply apparatus in accordance with the present invention, with the top cap of the assembly removed for clarity; and

FIG. 6 is a top plan view of the swirling assembly of the supply apparatus shown in FIG. 5, with the top cap of the assembly removed for clarity.

The embodiments of the tanks and of the apparatus for supplying a slurry to the tanks of the present invention are described hereinafter in the context of flash cooling a high temperature and pressure slurry from digestion units of Bayer process plants for producing alumina.

Typically, the slurry from the digestion units is at a temperature of at least 150° C.-140° C. and a pressure of at least 2500-300 kPa.

However, it is understood that the present invention is not limited to this application and extends to any other applications that require the use of the tanks and the supply apparatus for the tanks for flash cooling process slurries that are at high temperatures and pressures.

The tank, generally identified by the numeral 3, in FIG. 1 is a known tank that comprises a hemi-spherical lower section 9 and a hemi-spherical upper section (not shown) and cylindrical side walls 15.

The tank 3 also comprises a supply apparatus, generally identified by the numeral 5, for supplying the slurry at high temperature and high pressure into the tank 3 to be flash-cooled in the tank 3. Specifically, the slurry supplied to the tank 3 is at a temperature higher than the saturation temperature corresponding to an operating pressure of the tank.

The tank 3 also comprises at least one outlet 8 for discharging flash-cooled slurry from the tank 3. The tank 3 is one of a series of tanks for flash cooling high temperature and high pressure slurry from Bayer digestion units to atmospheric pressure at successively lower pressures in the tanks.

FIG. 1 shows that the tank 3 contains a pool 17 of flash-cooled slurry that has a surface that is at a level H₁ in the tank 3. The level H₁ may be any suitable level. The tank 3 includes sensors (not shown) for measuring the level of the pool 17. The control system for the tank 3 is set up to control the level of the pool 17.

The supply apparatus 5 comprises a riser tube 7 that is mounted to the lower section 9 of the tank 3 at the centre of the lower section 9 and extends vertically upwardly into the tank 3. The riser tube 7 has (a) an inlet 11 for the slurry in the lower section 9 and (b) an outlet, generally identified by the numeral 13, at an upper end of the riser tube 7. The inlet 11 is connected to an upstream source of the slurry. The source may be an upstream tank 3 or a digestion unit. The outlet 13 is at a level H₂ in the tank 3 that is above the level H₁ of the pool 17 of the flash-cooled slurry in the tank 3. The outlet 13 comprises a deflector in the form of a cap 14 that is connected to the top of the riser tube 7 via a series of radially extending vanes 16. It can be appreciated from the Figures that, in use, slurry flowing upwardly in the riser tube 7 contacts the top cap 14 and is deflected to flow radially outwardly in the gaps between the vanes 16 towards the side walls 15 and then downwardly into the pool 17 of flash cooled slurry.

Referring to FIGS. 3-6, each of the two, although not the only two, embodiments of the supply apparatus 5 in accordance with the present invention shown in the Figures comprises an assembly for imparting a swirling motion to the slurry flowing upwardly through the riser tube 7 from the inlet 11 to the outlet 13.

In each embodiment, the swirling assembly is located at the outlet 13 of the supply apparatus 5.

The arrows in FIGS. 3-6 illustrate the direction of flow of the slurry in each embodiment. In particular, the arrows show that in each embodiment the slurry flows upwardly from the inlet 11 through the riser tube 7 and then from the outlet 13 in a swirling motion. In each embodiment the swirling motion of the slurry from the outlet 13 is flow of the slurry in a curved path around a central vertical axis of the riser tube 7 outwardly and then downwardly from the outlet 13. In this context, the swirling motion is flow of the slurry that is not directly towards the side walls 15 of the tank 3 but rather is flow in a curved path of movement away from the outlet 13 and towards the side walls 15 of the tank 3 and then downwardly into the pool 17 of the flash-cooled slurry.

As is indicated above, the outlet 13 is positioned above the pool 17. Consequently, the slurry from the outlet 13 ultimately impinges on and contributes to the pool 17 of the flash-cooled slurry.

The effect of the swirling motion is to cause movement of the slurry within the tank 3 of each embodiment which ensures that there is movement of the entire volume of the slurry in the tank 3, for example enough tangential momentum of the slurry in the bottom of the tank 3, so that there is no settling of solid particulate material from the slurry to the bottom of the tank 3. In addition, the swirling motion of the slurry means that the slurry contacts the pool 17 of slurry in such a way that there is minimal splashing of the slurry onto the side walls 15 of the tank 3, thereby minimising scale formation on the side walls.

With reference to FIGS. 3 and 4, the swirling assembly of this embodiment comprises a plurality of vertically arranged curved blades 19 that are positioned in a circular array around the outlet 13 of the riser tube 7. As can be seen in the Figures, the blades 19 extend outwardly from a central vertical axis of the riser tube 7. The swirling assembly also comprises a top cover plate 25 that is positioned generally horizontally directly above the outlet 13 of the riser tube 7. In use, the slurry flowing upwardly in the riser tube 7 flows from the outlet 13 and contacts the under-surface of the cover plate 25 and is deflected radially outwardly directly towards the side walls 15 of the tank 3. The slurry contacts the curved blades 19 and is shaped by the blades 19 to flow in the curved path, i.e. with the swirling motion, shown by the arrows in the Figures.

The operating conditions in the tank 3 are controlled so that the level H₁ of the slurry in the tank 1 is below the outlet 13 of the supply apparatus 5.

The embodiment of the supply apparatus shown in FIGS. 5 and 6 is very similar to the embodiment shown in FIGS. 3 and 4.

The main difference between the embodiments is that the swirling assembly of the FIGS. 5 and 6 embodiment comprises an impeller device for imparting the swirling motion to the flow of slurry rather than the curved blades 19 of the FIGS. 3 and 4 embodiment.

Specifically, with reference to FIGS. 5 and 6, the impeller device comprises plurality of vertically extending impeller blades 27 arranged in a circular array around the outlet 13 of the riser tube 7. The swirling assembly also comprises deflector in the form of a cover plate (not shown). It can be appreciated that, in use, the impeller blades 27 have the same function as the curved blades 19 of shaping the radially outwardly flow of the slurry from the outlet 13 into the swirling motion.

The present invention is described further with reference to the following examples.

### Example 1

A reduced size flash tank having the same general shape as the tank shown in FIG. 1 was used to test the present invention.

The test tank comprises an acrylic cylindrical section and a hemi-spherical lower section, with an inlet and an outlet in the lower section of the test tank. The test tank has an approximate diameter of 0.4 meter. The height of the riser tube within the tank was varied between 0.1 and 0.23 m, when measured from base of the tank to below the outlet 13 when referring to FIG. 1.

The test tank was operated at ambient temperature and pressure.

The test slurry comprised solid particulate material suspended in water. The solid particulate material was in the form of glass beads having a particle size distribution approximating that of the slurries supplied to the current flash tanks used in the above-mentioned alumina plant of the applicant.

A pump was used to re-circulate test slurries from the tank outlet to the tank inlet.

Compressed air was injected into a feed pipe for the tank to simulate vapour flow produced due to pressure reduction.

The tests were carried out with test slurries supplied at similar superficial velocities to the slurries supplied to the current flash tanks used in the alumina plant.

Referring to FIG. 1 the outlet 13 on the top of the riser tube 7 in this example is of the type that projects the slurries radially outwardly toward the side walls of the tank without any induced swirl.

A range of different depths of slurries in the test tank was tested.

In all cases it was found that unacceptable amounts of solid particulate material settled out from the test slurries and accumulated in the bottom of the test tank.

### Example 2

Using the same set up as in example 1 and referring to FIG. 1, the outlet 13 on top of the riser tube 7 was modified to comprise a deflector cap to deflect at least a part of the radially outward flows of test slurries downwardly in the test tank but again without inducing any swirl to the exiting slurries.

Again, it was found that unacceptable amounts of solid particulate material settled out from the test slurries and accumulated in the bottom of the test tank.

### Example 3

Using the same set up as in examples 1 and 2 and referring to FIG. 1, the outlet 13 on top of the riser tube 7 was modified further to test the configurations shown in FIGS. 3-6 to induce swirling movement to the exiting slurry.

In all cases it was found that no solid particulate material settled out from the test slurries. In other words, under the range of operating conditions tested, the flow conditions in the test tank maintained the solid particulate material in suspension in the test slurries.

### Example 4

As is indicated above, the present invention was made after the applicant carried out research and development work on flash cooling tanks used in the above-mentioned plant of the applicant. The tanks have the construction shown in FIGS. 1 and 2, with the following tank dimensions:

Tank diameter: 5 m
Riser tube height: 2.5 m

The outlet 13 on top of the riser tube 7 of each flash tank deflects at least a part of the radially outward flows of the plant slurry downwardly in the flash tank without inducing any swirl to the exiting slurry.

With a solids concentration in the slurry of the order of 80 g/l, the bottom outlets of the flash tanks were generally completely blocked after a period of four (4) months in continuous operation and had to be taken out of service for complete clean up and descaling.

Moreover, after one month of operation some signs of blockages were observed in the flash tanks.

### Example 5

Using the same flash tanks as in example 4, but with outlets 13 on top of the riser tubes 7 having the configurations shown in FIGS. 3-6 that induce swirling movement to the exiting slurry, it has been observed that, after three (3) months of operation no scale had build up on the walls of the flash tanks and no deposits were observed at the bottom of the tanks.

Flash tanks equipped with the outlet design of the present invention have been able to operate on a trial basis for more than 6 months without any significant blockages.

The applicant has found that the tank and the supply apparatus of the present invention have the following advantages.
(a) Bottom entry of slurry means that it is not necessary for the slurry to undergo undesirable changes of direction and resultant momentum changes of slurry.
(b) The swirled flow of slurries from the outlet of the supply apparatus imparts enough movement of material in the tank, for example enough tangential momentum of slurries in the bottoms of the tanks to prevent settling of solid particulate material from the slurries.
(c) There is minimal wall splashing—such minimal wall splashing results in reduced wall scale growth—which can detach from the wall and block the tank outlet.
(d) There is a quiescent tank slurry level, resulting in a very defined liquid/vapour interface, making it possible to have improved level detection.

Many modifications may be made to the embodiments of the present invention described above without departing from the spirit and scope of, the invention.

By way of example, whilst the embodiments described above comprise a swirling assembly positioned at the outlet 3 of the riser tube 7, the present invention is not so limited and extends to any suitable position for the swirling assembly. For example, the present invention extends to arrangements in which the swirling motion is imparted at least partially within the riser tube 7.

1-25. (canceled)

26. An apparatus for supplying a slurry into a tank comprising:
(a) a riser tube comprising an inlet for receiving the slurry into the tube and an outlet for discharging the slurry from the tube; and
(b) an assembly for imparting a swirling motion to the slurry.

27. The apparatus defined in claim 26, wherein the swirling assembly is positioned at the outlet of the riser tube.

28. The apparatus defined in claim 26 or claim 27, wherein the swirling assembly comprises a plurality of curved blades positioned in a flow path of the slurry at the outlet of the riser tube.

29. The apparatus defined in claim 26, wherein the swirling assembly comprises a plurality of impeller blades positioned in a flow path of the slurry at the outlet of the riser tube.

30. The apparatus defined in claim 26, wherein the swirling assembly comprises a plurality of rotatable vanes positioned in a flow path of the slurry at the outlet of the riser tube.

31. The apparatus defined in claim 26, wherein the swirling assembly further comprises a deflector positioned directly above the outlet of the riser tube for imparting a downward flow to the slurry flowing from the outlet of the riser tube when the assembly is positioned in the tank.

32. The apparatus defined in claim 30, wherein the deflector comprises a cap having a top wall and optionally a downwardly-depending skirt that is positioned on the swirling assembly so that, in use, the slurry that flows from the outlet of the riser tube contacts the top wall and/or the skirt and is deflected downwardly in the tank.

33. A tank for cooling a slurry, the tank comprising:
(a) the apparatus for supplying the slurry to be cooled into the tank defined in claim 26, positioned in the tank, and
(b) at least one outlet for cooled slurry from the tank.

34. The tank defined in claim 33, wherein the tank is a tank for flash cooling a slurry that is at a temperature higher than the saturation temperature corresponding to an operating pressure of the tank.

35. The tank defined in claim 34, wherein the tank is a tank for flash cooling a slurry from digestion units of Bayer process plants for producing alumina.

36. The tank defined in claim 33, wherein the supply apparatus is positioned in the tank with the riser tube mounted to a bottom of the tank and extending upwardly in the tank, whereby in use of the tank the outlet is positioned above a pool of the slurry in the tank.

37. The tank defined in claim 36, wherein the riser tube extends vertically upwardly and is positioned centrally in the tank.

38. A method of processing a slurry that comprises supplying the slurry with a swirling motion into a tank that contains a pool of the slurry.

39. The method defined in claim 38, comprising supplying the slurry to the tank at a temperature higher than the saturation temperature corresponding to an operating pressure of the tank and flash cooling the slurry in the tank.

40. The method defined in claim 39, wherein the slurry is a slurry from digestion units of Bayer process plants for producing alumina.

41. The method defined in claim 38, comprising supplying the slurry with the swirling motion into the tank above a surface of the pool of the slurry in the tank.

42. The method defined in claim 38, comprising supplying the slurry with the swirling motion into the tank in a downward direction within the tank.

43. The method defined in claim 38, comprising supplying the slurry in an upward flow, or a vertically upward flow, from a bottom of the tank via a riser tube positioned in the tank and imparting the swirling motion to the slurry as it flows from an outlet of the tube at an upper end of the tube.

44. The method defined in claim 38, comprising controlling the level of the pool of the slurry in the tank.

45. An apparatus for supplying a slurry into a tank comprising:
(a) a riser tube comprising an inlet for receiving the slurry into the tube and an outlet for discharging the slurry from the tube; and
(b) an assembly for imparting a swirling motion to the slurry, the assembly comprising a deflector positioned directly above the outlet of the riser tube for imparting a downward flow to the slurry flowing from the outlet of the riser tube when the assembly is positioned in the tank, and the assembly comprising a plurality of vertically arranged blades positioned in a circular array around the outlet whereby, in use of the apparatus, the slurry flowing upwardly in the riser tube flows from the outlet and contacts the deflector and is deflected radially outwardly and contacts the blades and is shaped by the blades to flow with the swirling motion.

46. The apparatus defined in claim 45, wherein the blades are fixed blades.
